(19) United States
(12) Patent Application Publication
(10) Pub. No.: US 2003/0215218 A1
(43) Pub. Date: Nov. 20, 2003

(54) System and method of processing audio/video data in a remote monitoring system

(75) Inventor: Hosung Chang, West Islip, NY (US)

Correspondence Address: Frank Chau, Esq., F. CHAU & ASSOCIATES, LLP, Suite 501, 1900 Hempstead Turnpike, East Meadow, NY, 11554, US

(73) Assignee: Intelligent Digital Systems, LLC

(21) Appl. No.: 10/145,058

(22) Filed: May 14, 2002

(51) Int. Cl. H04N 5/91; H04N 7/04; H04N 7/06; H04N 7/08; H04N 7/52

(52) U.S. Cl. 386/96

(57) ABSTRACT

A system and method are provided for processing audio/video (A/V) data provided from multiple A/V sources. The system includes A/V data capture devices for receiving the A/V data, each of which receives A/V data from a predetermined number of A/V sources; drivers for driving output data of the A/V data capture devices for a first set of application programs, each of the drivers receiving output data from corresponding one of the A/V data capture devices and being associated with corresponding one of the first set of application programs; virtual drivers for driving input data for a second set of application programs, each of the virtual drivers being associated with corresponding one of the second set of application programs; and a channel mapping unit for mapping data from the drivers into the virtual drivers.

### BACKGROUND OF THE INVENTION

1. Field of the Invention

The present invention relates to a system and method of processing audio/video data, more particularly, to a system and method of processing audio/video data provided from local and remote audio/video sources, and a system and method of monitoring certain areas using the system and method of processing audio/video data.

2. Description of the Related Art

Generally, a monitoring system has a data process system for processing video data provided from local and remote video sources such as cameras.

Referring to FIG. 1, a block diagram is provided for illustrating a typical data process system applicable to a conventional monitoring system. In the data process system 10, a video data capture device 11 is provided to capture video data transmitted from video sources such as cameras VS1-VS3. The video sources VS1-VS3 used to monitor certain areas generate video signals representing objects and/or certain movements in the areas. The video sources VS1-VS3 may be located in local or remote areas from the system 10. The video data capture device 11 process the video signals from the video sources to provide digital video data.

The data process system 10 also has a driver 13 for driving the video data capture device 11. The driver 13 may be a program routine that links a peripheral device to an operating system of the data process system 10. The driver 13 may be written by programmers who understand the detail knowledge of the video data capture device's command language and characteristics, so that the driver 13 may contain machine language necessary to perform the functions requested by an associated application program. In the data process system 10, the driver 13 drives the video data capture device 11 so that video data output from the video data capture device 11 is processed in accordance with an application program associated with the driver 13.

Video data provided from the driver 13 is transmitted to a user interface 15 which generally has a display unit to display the video data. The transmission of video data from the driver 13 to the user interface 15 is controlled by a control unit 17 to which a user can provide user input data. Also, the video data from the driver 13 may be transferred to and stored in a data storage 19 under control of the control unit 17.

In a conventional monitoring system, the video data capture device 11 may be connected with one or more audio sources such as microphones. The audio sources obtain sound from the areas to be monitored and provide audio signals to the video data capture device 11. In this case, the video data capture device 11 also has a function of capturing and processing audio signals from the audio sources to produce digital audio data.

However, in the data process system for a conventional monitoring system, there is generally a limit to the amount of capturing and recording of video data. Generally, a video data capture device can only process input video signals at the speed of maximum thirty (30) frames per second.

Also, in the process and transmission of audio signals, the conventional data process system may have only one audio channel between audio sources and a user interface or a data storage device. The conventional data process system does not provide channels through which two-way communication is feasible between a user interface and audio sources. Typically, in the conventional monitoring system, only one audio channel is provided for recording audio data.

When a data process system in a conventional monitoring system employs only physical drivers such as the driver 13 in FIG. 1, the data process system is limited to an application program associated with a physical driver used therein.

Also, data streaming is usually based on local demand priority in a conventional monitoring system. Thus, data streaming processes such as data computer, bit rate, and transmission size coding are performed in a conventional digital video recorder (DVR). The conventional approach has difficulty in streaming with reasonable quality for remote live transmission because of lack of dynamic compression switching capabilities. Conventional streaming video uses a constant value bit rate at which server transmits to subscriber receivers. If this constant bit rate is significantly violated, serious latency problems develop. In such case, the CPU must devote significant resources to smoothen the video; otherwise the received video is at an unstable media state, and motion picture quality suffers.

In a conventional data process and monitoring system, video or audio data is simply stored in a data storage device. To perform data searching, a user need to perform a sequential search to find or retrieve specific data from the stored video or audio data. The time required for performing a sequential search depends on the amount of the stored data to be searched. Thus, in case that a large amount of video or audio data is stored in a storage device, a large amount of time may be needed to perform the search.

Therefore, a need exists for a video and/or audio data process system applicable to a remote monitoring system having a plurality of data process channels capable of integrating a plurality of heterogenus resources. It would also be advantageous to provide a remote monitoring system having bidirectional communication function between user interfaces and video/audio sources at areas to be monitored. It is also desired to provide a monitoring system having a user defined search functions such as defined color, motion, or other objects to facilitate searching recorded video or audio data using a text query.

### SUMMARY OF THE INVENTION

The present invention provides a system for processing video data provided from a plurality of video sources. The system includes multiple video data capture devices for receiving the video data, each of the video data capture devices receiving video data from a predetermined number of video sources; multiple video drivers for driving output data of the video data capture devices for a first set of application programs, each of the video drivers receiving output data from corresponding one of the video data capture devices and being associated with corresponding one of the first set of application programs; multiple virtual video drivers for driving input data for a second set of application programs, each of the virtual video drivers being associated with corresponding one of the second set of application programs; and a video channel mapping unit for mapping data from the video drivers into the virtual video drivers.

The system may further include multiple audio sources for providing audio data; multiple audio data capture devices for receiving the audio data, each of the audio data capture devices receiving audio data from a predetermined number of audio sources; multiple audio drivers for driving output data of the audio data capture devices for the first set of application programs, each of the audio drivers receiving output data from corresponding one of the audio data capture devices and being associated with corresponding one of the first set of application programs; multiple virtual audio drivers for driving input data for the second set of application programs, each of the virtual audio drivers being associated with corresponding one of the second set of application programs; and an audio channel mapping unit for mapping data from the audio drivers into the virtual audio drivers.

Preferably, the video sources and the audio sources are combined to form A/V sources for generating A/V data; the video data capture devices and the audio data capture devices are combined to form A/V data capture devices for receiving the A/V data from the A/V sources; the virtual video drivers and the virtual audio drivers are combined to form virtual A/V drivers each of which drives input A/V data to be processed in accordance with corresponding one of the second set of application programs; the video channel mapping unit and the audio channel mapping unit are combined to form an A/V channel mapping unit for mapping data from the A/V drivers into the virtual A/V drivers. The system may further include A/V remote sources.

According to another aspect of the present invention, a method is provided for processing A/V data provided from various A/V sources. The method includes the steps of providing physical local channels for transmitting A/V data provided from local A/V sources, each of the physical local channels transmitting A/V data from corresponding one of the local A/V sources; providing logical channels virtually created in association with various application programs, each of the logical channels driving input data to be processed in accordance with corresponding one of the various application programs; and mapping the physical local channels into the logical channels such that A/V data transmitted via each of the physical local channels is provided as input data to corresponding one or more of the logical channels. The method may also include providing physical remote channels for transmitting A/V data provided from remote A/V sources via a communication network including a global computer network, and mapping the physical remote channels into the logical channels such that A/V data transmitted via each of the physical remote channels is provided as input data to corresponding one or more of the logical channels.

The present invention also provides a system for monitoring predetermined areas. The system includes video sources providing video signals obtained from the areas, each of the video sources being used to monitor at least one area; a video data capture unit for receiving the video signals from the video sources and processing the video signals to provide digital video data; a video channel mapper for mapping the digital video data from the video data capture unit into logical video channels which are associated with various application programs such that each logical video channel drives video data to be processed in association with corresponding one or more of the various application programs; and a display unit for displaying video data provided from the video channel mapper via the logical video channels. The system may also include audio sources providing audio signals obtained from the areas, each of the audio sources being used to monitor at least one area; an audio data capture unit for receiving the audio signals from the audio sources and processing the audio signals to provide digital audio data; an audio channel mapper for mapping the digital audio data from the audio data capture unit into logical audio channels which are associated with the various application programs such that each logical audio channel drives audio data to be processed in association with corresponding one or more of the various application programs; and an audio generator for generating sound in response to the audio data provided from the logical audio channels.

Preferably, the video sources and the audio sources are combined to form A/V sources each providing A/V signals; the video data capture unit and the audio data capture unit are combined to form an A/V data capture unit for receiving the A/V signals from the A/V sources and processing the A/V signals to produce digital A/V data; the video channel mapper and the audio channel mapper are combined to form an A/V channel mapper for mapping the digital A/V data from the A/V data capture unit into logical A/V channels which are associated with the various application programs such that each of the logical A/V channels drives A/V data to be processed in association with corresponding one or more of the various application programs; and the display unit and the audio generator are combined to form an A/V display unit for receiving A/V data from the A/V channel mapper via the logical A/V channels and displaying the received A/V data. The system may also include remote A/V sources which provide A/V data and are located remotely from the system via a remote communication network, wherein the A/V channel mapper maps A/V data from the A/V data capture unit and the remote A/V sources into the logical A/V channels. The system may further include an event processor for producing event data by defining objects or events in the areas; an event data storage unit for storing the event data provided from the event processor under control of the database control unit.

According to another aspect of the present invention, there is provided a method for monitoring predetermined areas, including the steps of providing physical video channels for transmitting video data obtained from video sources located in the areas; providing logical video channels virtually created in association with various application programs, each of the logical video channels driving input data to be processed in accordance with corresponding one of the various application programs; mapping the physical video channels into the logical video channels; and displaying video data provided from the logical video channels, video data from each of the logical video channels being displayed on a window of a screen. The method may also include providing physical audio channels for transmitting audio data obtained from audio sources located in the areas; providing logical audio channels virtually created in association with the various application programs, each of the logical audio channels driving input data to be processed in accordance with corresponding one of the various application programs; mapping the physical audio channels into the logical audio channels; and generating sound in response to audio data provided from the logical audio channels.

Preferably, the method further includes combining the video sources and the audio sources to form A/V sources to provide A/V data; combining the physical video channels and the physical audio channels to form physical A/V channels for transmitting the A/V data from the A/V sources; combining the logical video channels and the logical audio channels to form logical A/V channels virtually created in association with the various application programs, each of the logical A/V channels driving input A/V data to be processed in accordance with corresponding one of the various application programs; and mapping the physical A/V channels into the logical A/V channels. The method may also include forming event data by defining objects or events in the areas by providing event text representing each of the defined objects or events, providing A/V data unit ID for identifying each of the plurality of A/V data units, and associating the event text and the A/V data unit ID to form the event data; and storing the event data such that stored event data is associated with the stored A/V data.

These and other objects, features and advantages of the present invention will become apparent from the following detailed description of illustrative embodiments thereof, which is to be read in connection with the accompanying drawings.

### BRIEF DESCRIPTION OF THE DRAWINGS

This disclosure will present in detail the following description of preferred embodiment with reference to the following figures wherein:

FIG. 1 is a block diagram illustrating a video data process system applicable to a conventional monitoring system;

FIG. 2 is a block diagram illustrating an audio/video (A/V) data process system applicable to a remote monitoring system according to a preferred embodiment of the present invention;

FIG. 3 is a block diagram illustrating the A/V data capture unit in FIG. 2 according to a preferred embodiment of the present invention;

FIG. 4A is a block diagram illustrating the database control unit in FIG. 2 according to a preferred embodiment of the present invention;

FIG. 4B is a schematic diagram for describing formation of event data according to the present invention; and

FIGS. 5A and 5B are comparative block diagrams for describing a static zoom and a dynamic zoom according to the present invention.

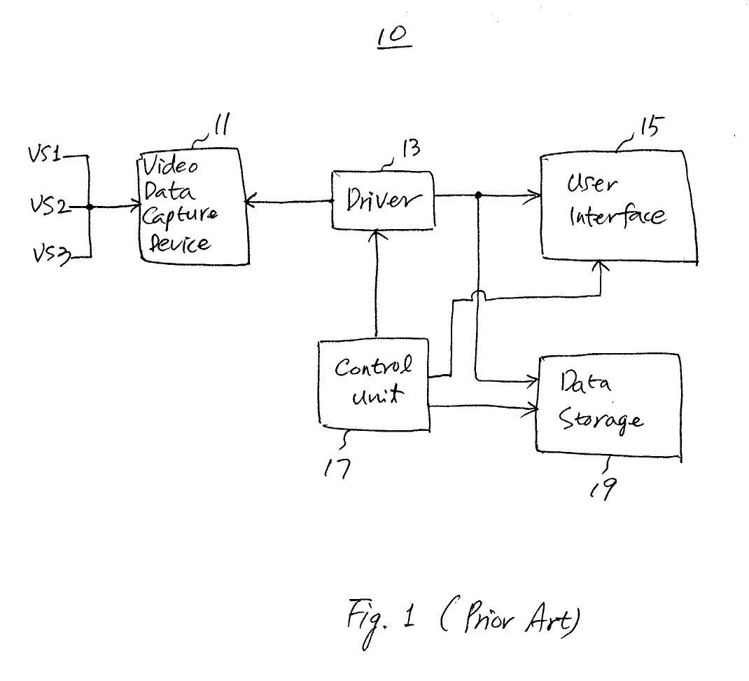

### DESCRIPTION OF PREFERRED EMBODIMENTS

Detailed illustrative embodiments of the present invention are disclosed herein. However, specific structural and functional details disclosed herein are merely representative for purposes of describing preferred embodiments of the present invention.

The present invention relates to a system and method of processing audio/video (A/V) data captured by multiple A/V sources by employing features such as high speed capturing and recording of A/V data, high speed data streaming, logical channel mapping, etc. The invention also relates to a remote monitoring system employing the system and method of processing A/V data, which include features such as a quick search of stored A/V data using a text query, more flexible screen editing, etc.

The A/V data process system of the present invention is applicable to a security system for monitoring designated areas, and the remote monitoring system of the present invention may be used to replace existing security or monitoring systems. By employing the remote monitoring system of the present invention, it will be feasible to perform, in addition to the conventional security monitoring functions such as door opening, glass breaking, pressure on a pressure pad, etc., facial recognition, color and motion recognition of target objects and events in areas to be monitored, monitoring local or remote locations, bidirectional audio communication which allow providing a remote guide to persons at remote locations, and transmission of A/V data to portable monitor or computer, hand-held “palm”, or other personal information management tools.

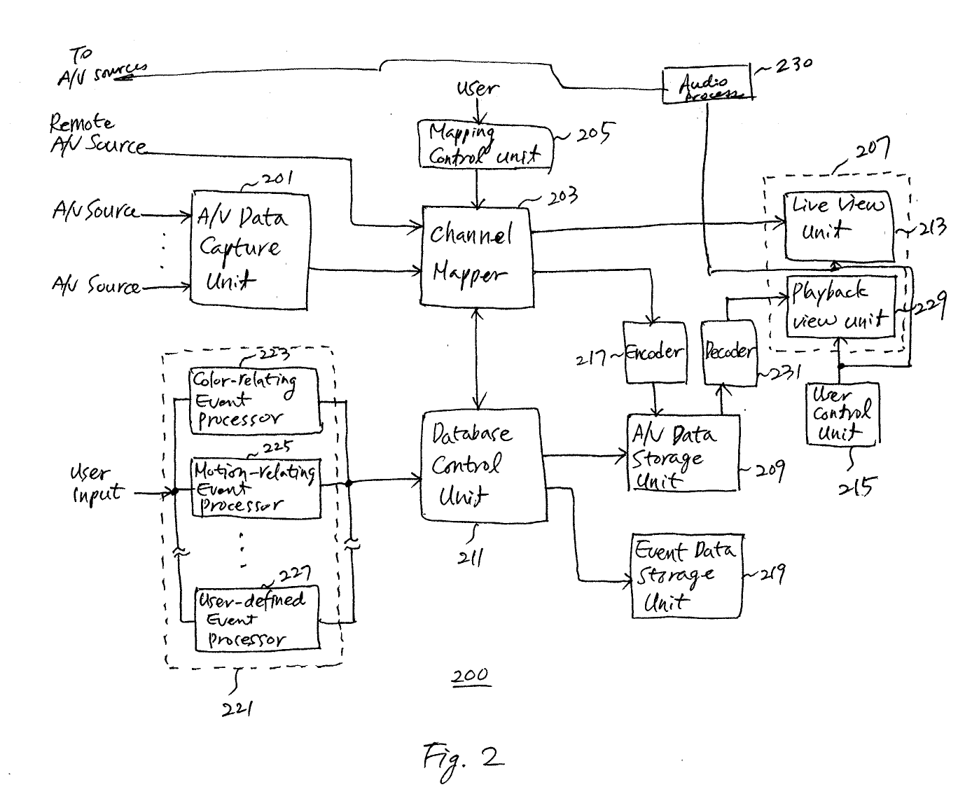

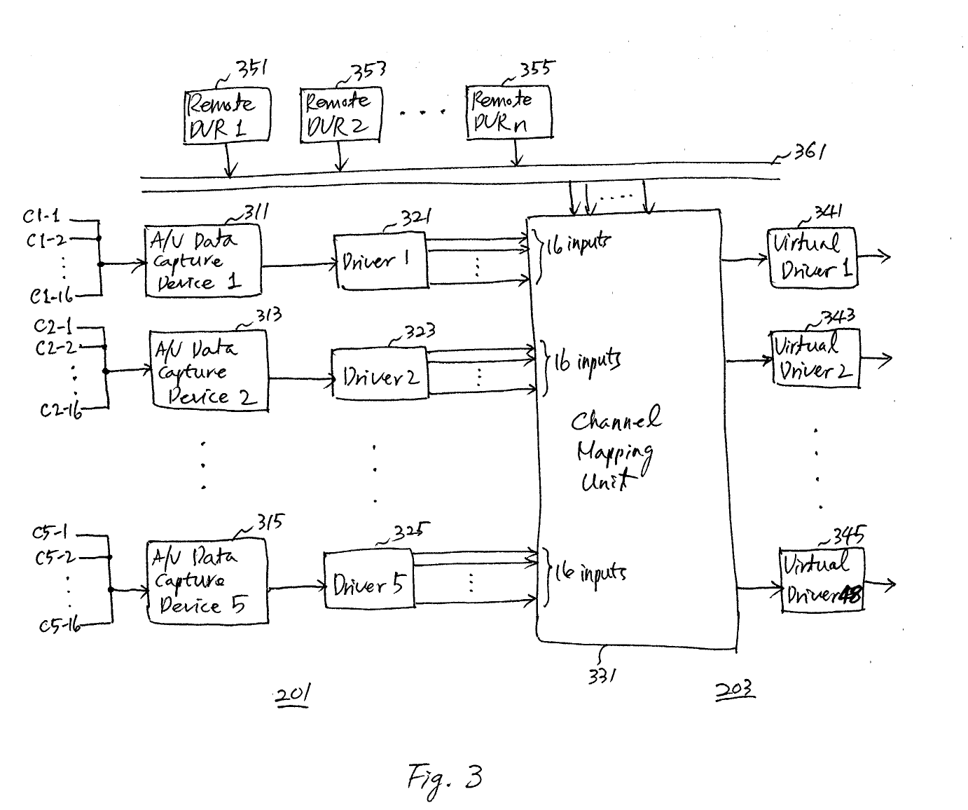

Referring to FIG. 2, there is provided an A/V data process system applicable to a monitoring system according to a preferred embodiment of the present invention. In the A/V data process system 200, A/V sources located at areas to be monitored provide A/V signals obtained from target objects, movements, and sound. The number of A/V sources may vary depending on the number of areas to be monitored and/or the number of target objects at the monitored areas. The audio and video sources are, for example, microphones and cameras, respectively. The A/V signals from the A/V sources are provided to an A/V data capture unit 201. The A/V data capture unit 201 processes the captured A/V signals from the A/V sources and converts the captured signals to digital A/V data. The A/V data capture unit 201 is described in detail below with reference to FIG. 3.

In the A/V data process system 200, a channel mapper 203 receives digital A/V data provided from the A/V capture unit 201 for logically mapping the input data into virtual device drivers which are logically or virtually created in association with various application programs. Preferably, the channel mapper 203 also receives A/V data from remote A/V sources via a remote communication network such as the Internet. The channel mapper 203 may be implemented by either hardware or software or combination thereof. The channel mapper 203 receives from a mapping control unit 205 control data to control, set up, and/or modify operation and programs in the channel mapper 203. A detailed description of the channel mapper 203 is provided below with reference to FIG. 3.

The data process system 200 also includes a display unit 207 for displaying A/V data provided from the channel mapper 203. The display unit 207 preferably has a live view unit 213 and a playback view unit 229 connected to a monitor (not shown). The live view unit 213 processes streaming data and causes the display of live or real-time video. The playback view unit 229 processes recorded video data. The display unit 229 is capable of processing A/V signals from multiple sources and display multiple windows, each of which displays video data transmitted via a corresponding channel from a video source (e.g., a camera).

The display unit 207 receives control data from a user control unit 215, which interfaces with a user. By sending the control data using the user control unit 215, a user may set up and/or modify sizes and locations of each of the windows on a screen, and designate certain windows to particular channels or AV sources. Also, the user control unit 215 can set all or some of the windows to display video data transmitted from remote A/V sources through a remote communication network. In other words, under control of the user control unit 215, a screen on the live view unit 213 may have multiple windows, some of which display video data provided via local channels from local video sources and other some of which display video data provided via remote channels from remote video sources. While the conventional monitoring systems have limited number of windows on a screen and the windows each have a fixed size, the A/V monitoring system of the present invention is capable of allowing a user to configure any number and variable sizes of windows on a screen and to restore them when needed. The user control unit is preferably in the form of a keyboard and a mouse. Speakers are provided to output the audio signals. All the required information for a current screen layout can be saved into a file named by a user. For variable windows editing, 1) User defines a window, size, and position, using a program module such as the Program Live Viewer; 2) User defines video channels property which becomes one of local camera, remote camera, or external video capture device, using Program Service Daemon program or the like; 3) User specifies which channel is adopted for this window, using Program Configuration; 4) User creates as many windows as a single monitoring screen page, and saves it; and 5) the variable windows definition is activated by connecting Live Viewer, Configuration, and Service Daemon.

The user control unit 215 also controls audio process 230 for receiving and transmitting audio signals. A user can locally and remotely monitor and communicate with objects or persons at the local and remote monitored areas. For example, when an alarming event is detected at a remote site, a monitoring station operator (not shown) monitors the remote video source and may turn on/up the audio channel corresponding to the remote source in a listen-only mode. The operator may choose to communicate or warn persons at the remote source by changing the channel to a listen-and-talk mode. A proper announcement or warning can be made to handle the situation at the remote site.

According to a preferred embodiment of the invention, audio process 230 includes video processing capabilities to receive both audio and video signals generated by the user at the user control unit 215. In such embodiment, microphones and video cameras can be trained to the user and the announcement or warning can be presented to persons at the remote site. This feature may be effective if the operator is a uniformed guard and his image and verbal announcement is presented at a monitor at the remote site to notify the person that he is monitored and to discourage further illicit or illegal activities.

The A/V data provided via the local and remote channels are stored in an A/V data storage unit 209 under control of a database control unit 211. For the process of storing A/V data in the A/V data storage unit 209, the A/V data output from the channel mapper 203 is encoded or compressed by an encoder 217. When the encoded A/V data is stored in the storage unit 209, locations to be stored and the amount of data to be stored in each location are preferably determined by the database control unit 211. The encoder 217 may have separate encoders for video data and audio data, respectively.

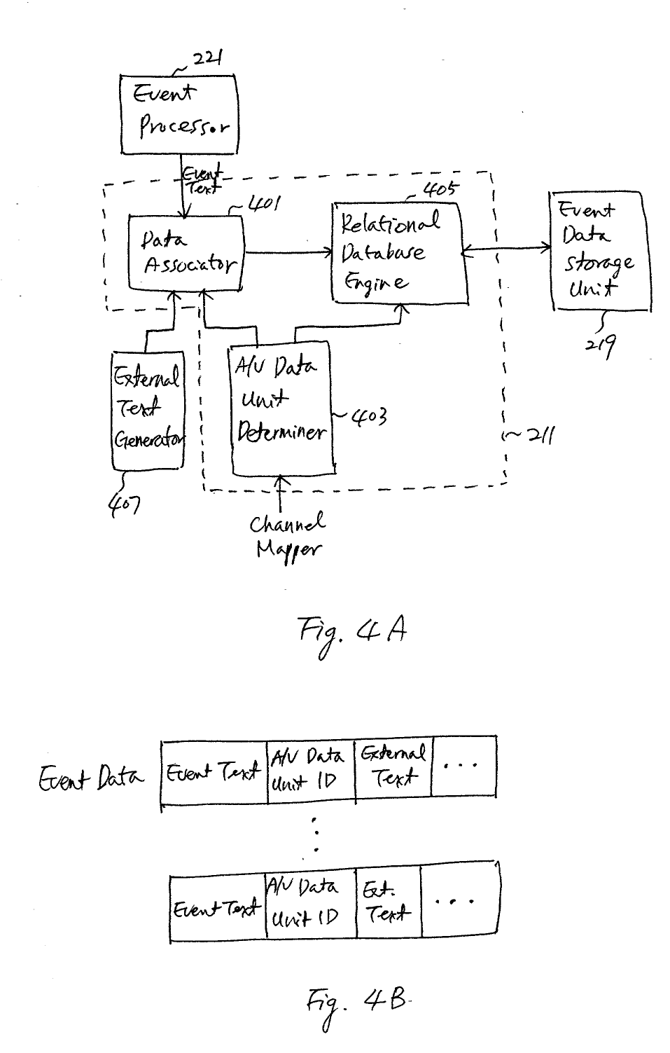

The database control unit 211 also controls storing and retrieving event data into and from an event data storage unit 219. Event data may represent a single event, multiple events, a single object, or multiple target objects defined by a user. Event data stored in the event data storage unit 219 is associated with A/V data stored in the A/V data storage unit 209 in terms of events defined by a user. The database control unit 211 is described in detail below with reference to FIGS. 4A and 4B.

A user can define events and/or objects in areas to be monitored by providing an event processor 221 with input data setting forth criteria for each event and/or object. The event processor 221 preferably includes multiple sub-processors each for producing particular event texts each representing target objects or events defined by a user. Target objects can be defined at system install or when changes are detected in the monitored area. As an example, when a monitoring system is installed at a facility, the area to be monitored by an A/V source device is defined (e.g., all objects within view of the camera is defined). Then, other characters such as colors can be defined to a color-relating event processor 223 which receives input data defining color-relating events, where each event is defined in association with particular colors of target object(s). For example, a yellow van passing through a monitored area is captured. The change in the scene can be defined as yellow. Subsequent data searched using keyword ‘yellow’ in color search will bring up all frames having ‘yellow’ defined. A motion-relating event processor 225 receives input data defining motion-relating events, wherein each event is defined in association with movements in the target area. Thus, the color-relating event processor 223 and the motion-relating event processor 225 generate color-relating event texts and motion-relating event texts, respectively. The event processor 221 may also include a user-defined event processor 227 for defining each event in accordance with what a user has defined or set up for each event or object at a specific area. It should be noted that the event processor 221 may include sub-processors other than the color- and motion-relating and user-defined event processors 223-227.

The event processor 221 provides the event texts to the database control unit 211 which subsequently produces event data to be stored in the event data storage unit 219. Formation of the event data is described in detail below with reference to FIG. 4A. The event data is stored in association with A/V data provided from the channel mapper 203. In other words, each and every event is associated with a particular A/V data provided through a particular logical or virtual channel. The database control unit 211 controls storing of certain event data and A/V data associated with the event data in the event data storage unit 219 and the A/V data storage unit 209, respectively. Thus, a query can be performed with respect to a certain event by finding event data representing the event and retrieving ANV data associated with the event data. The retrieved ANV data is transferred to the display unit 207. Then, the playback view unit 229 in the display unit 207 displays video data provided from the A/V data storage unit 209. Since the A/V data stored in the A/V storage unit 209 is compressed by the encoder 217, the A/V data retrieved from the A/V storage unit 209 is decompressed by a decoder 231.

When a user inputs data to define each event in the event processor 221, the data may be composed with a single or more texts. For example, an event or object relating a color may be defined by setting the event data as “red color”, and an event or object relating to motion may be defined by setting the event data as “horizontal movement from the left to the right”. By combining the event data relating to color and motion, a specific event or object can be defined such as, “red color and horizontal movement from the left to the right”. Since an event or object may be defined with texts, a user can find event data associated with the texts from the event data storage unit 219 by making a “text query”, a search of the event data using the texts defining certain events or objects. As examplary illustration of the “text query” feature follows:

1) DVR users registered channel 5 color/motion event as “school bus coming”

2) DVR users registered external sensor glass breaker #3 as “Front window broken”

3) Yellow color event detected and recorded in database as:

Evented time+Logical Association information bit mask+Event Type+Event Text

=>bit 4 set (channel 5 is associated to this event: software event

4) Some students from the school bus with the yellow color broke the window.

5) Glass break sensor detects the window breaking, and event processor 221 records the event as

Evented time+Logical Association information bit mask+Event Type+Event Text

=>bit 0, 2, 4 set (channel 1, 2, 5 are associated to this event: hardware event)

6) Owner of this broken building tries to find who broke his window. Query: Window and broken =>he takes the 3 minutes clip pre and post glass breaking event.

7) User finds all events related to the same video clip, e.g., school bus coming.

8) User queries again Windows broken and school bus. He finds the exact time when the school bus coming. He can take the picture and print.

Query time is under 3 seconds in local system, under 15 seconds for remote playback.

Referring to FIG. 3, a block diagram is provided for describing the A/V data capture unit 201 and the channel mapper 203 in FIG. 2 according to a preferred embodiment of the present invention. The A/V data capture unit 201 includes multiple A/V data capture devices 311-315, each of which receives A/V signals from multiple A/V sources (C1-1 to C5-16) such as cameras and microphones. Each of the A/V data capture devices is associated with a driver to drive the data processed in a corresponding A/V data capture device in accordance with an operating system of the A/V monitoring system of the present invention.

The A/V data capture unit 201 employs, for example, five (5) A/V data capture devices 311-315 each of which receives A/V signals from, for example, sixteen (16) A/V sources. It should be noted that the number of A/V data capture devices and the number of A/V sources may be varied from five (5) per A/V capture unit and sixteen (16) per an A/V data capture device without departing from the invention. Each of the A/V data capture devices performs a analog-to-digital (A/D) convert function with respect to A/V analog signals from associated A/V sources to generate digital A/V data.

Advantageously, the multiple processor multi-tasking capabilities of the A/V data capture unit 201 facilitates A/V data capturing and storing at much higher speed in the system of the present invention than that in the conventional systems. For example, the data process of A/V signals in each A/V data capture device is performed at the speed of 30 frames per second, the data process speed in the A/V data capture unit 201 becomes 150 frames per second.

According to a preferred embodiment of the present invention, dynamic bit-rate communication is employed for streaming data. As an example, in remote live streaming and playback, DVRs transmit at the best bit-rate pursuant to request by data capture unit, (e.g., transmit each live frame at max rate), the DVR compresses the frame and forwards the compressed frame to the data capture unit for processing and display of each live frame.

The A/V data capture unit 201 also includes multiple drivers 321-325 each for driving the respective A/V data capture devices 311-315. Each of the drivers 321-325 supports the associated A/V data capture device. In other words, the A/V data capture devices can take many different forms, such as a USB camera, a sensitive microphone, or a color digital camera. Each driver supports the specific characteristics of the A/V source device. In FIG. 3, the A/V sources, the A/V data capture devices 311-315, and the drivers 321-325 constitute physical local channels. Since in a preferred embodiment according to the present invention, each A/V data capture device receives A/V signals from sixteen (16) A/V sources, sixteen (16) channel inputs are allocated for each capture device by the channel mapper 203. In this embodiment, the sixteen (16) A/V sources may be sixteen (16) cameras as one type of the video sources. The sixteen (16) inputs in the channel mapper 203 may have various kinds of physical connections with external devices such as USB camera, digital camera, Web camera, etc. Advantageously, the sixteen (16) inputs can be heterogenous devices. They are integrated into a common platform by logical channel, (e.g., using Microsoft visual C++) and processed by channel mapper 203. Preferably, the application layer program components use a single homogeneous video buffer independent of the different device types such as drivers for local, remote, and external video devices and filters. The logical channel receives the different inputs and provides 1:N addressing and synchronization. Configuration program is used to define logical channels by specific device type. An exemplary pseudo code for performing logical channel is:

BYTE* CAr::GetVBuf(BYTE iChan, LONGLONG** ppT) // acquire video buffer and time stamp from all
video sources
{

BYTE* pFrame=NULL;
BOOL bUseTia=FALSE; //to find techeye remote or external device flag
for(int i=0; i<_TI_REMOTE_CHANS; i++) {

if(s_TiCfg.UseTia[iChan][i]==1) { //share memory by configuration program

bUseTia=TRUE;
break;

}

}
if(bUseTia) { //remote channel for tia, or external device

//find the associated logi chan
for(int i=0; i<_TI_REMOTE_CHANS; i++) {

if(s_Rem[i].llMaskLogiChan&(LONGLONG(1)<<LONGLONG(iChan))) {

pFrame=&s_Rem[i].pFrame[0];
*ppT=&s_Rem_tFrame[i];
break;

}

}
if(!pFrame) return NULL;

}
else { //local TechEye devices

USHORT iBoard=s_TiCfg.chanmap[iChan].brd;
USHORT iPrt=s_TiCfg.chanmap[iChan].prt;
LONGLONG tFrame=0;
ULONG iCam=0;
}

}
return pFrame;

}

if(svc_StartupOpt.iBoardType[iBoard]==BOARD_TYPE_L4) {

if(iPrt<4) {

pFrame=&cmn_[iBoard].fBuf[MX_FBUF*iPrt];
*ppT=(LONGLONG*)&cmn_L4[iBoard].t;

}

}
else {

pFrame=&sh_drvMV[iBoard][iPrt][0]+sizeof(ULONG)*4;
*ppT=(LONGLONG*)(&sh_drvMV[iBoard][iPrt][0]+sizeof(ULONG));

}

}
return pFrame;

}

The channel mapper 203 preferably includes a channel mapping unit 331 and multiple virtual drivers 341-345. The channel mapping unit 331 receives digital A/V data provided from the drivers 321-325 and performs a mapping of the input A/V data into the virtual drivers 341-345. Also, the channel mapping unit 331 may receive A/V data from remote A/V sources such as remote digital video recorders (DVRs) 351-355. Each of the remote DVRs may be a conventional DVR or the A/V monitoring system of the present invention. A/V data generated from the remote DVRs is transmitted to the channel mapping unit 331 through a communication network 361 which includes, but not limited to, a telephone line network, a cable line network, a digital subscriber line (DSL) network, a T-1 network, a wireless network, a global computer network for the Internet, and so on.

The virtual drivers 341-345 are preferably logical drivers, in other words, software drivers which are logically connected to drive input data and virtually created in association with various application programs. Each of the virtual drivers 341-345 is are used to drive A/V data provided from the channel mapping unit 331 so that the various application programs can be implemented with respect to the A/V data. By providing the virtual drivers 341-345 to the system, virtual or logical channels are formed between the channel mapping unit 331 and other peripheral devices such as a user interface and a data storage unit.

In FIG. 3, for example, the channel mapping unit 331 distributes the input data (e.g., maximum 80 inputs) into the forty-eight (48) virtual drivers 341-345. It is noted that the number of the virtual drivers may vary from one (1) to forty-eight (48) or more. The mapping of the input data into the virtual drivers in the channel mapping unit 331 may be determined by data provided from the mapping control unit (205 in FIG. 2).

In FIG. 3, there may be up to eighty (80) physical local channels each from a corresponding A/V source to an input to the channel mapping unit 331 through an A/V data capture device and a driver. Also, there may be physical remote channels each from a remote DVR to an input to the channel mapping unit 331 through the communication network 361. In this example, since there are five drivers 321-325 to drive the A/V data capture devices 311-315 in the physical local channels, five application programs are available to the A/V data captured and processed by the physical local channels. In the channel mapper 203, however, the physical local and/or remote channels are mapped into the logical channels (e.g., forty-eight channels) so that the A/V data from the physical local/remote channels can be processed in association with more various application programs. Since there are, for example, forty-eight virtual drivers each for the respective logical channels, forty-eight application programs may be implemented with respect to A/V data mapped in the channel mapping unit 331.

Advantageously, more application programs may be supported by the virtual drivers 341-345. For example, the remote channels may be mapped along with the local channels, and various screen editing is available in the display unit (207 in FIG. 2). Also, the same A/V data can be processed in association with two or more different events by mapping a single physical channel into multiple logical channels. For example, A/V data on a single physical channel can be stored in lower quality data in case that event A occurs, and stored in high quality data in case that event B occurs.

Compared with the conventional monitoring systems where only one audio channel is provided for recording audio data in a storage unit, the A/V monitoring system of the present invention has multiple audio channels as well as video channels. In the system shown in FIGS. 2 and 3, for example, the system has forty-eight (48) logical channels each including a virtual driver. Using the audio channels according to the present invention, audio data transferred via audio channels (e.g., 9 audio channels) can be simultaneously recorded, and two-way audio communication can be performed simultaneously in all the audio channels.

Referring to FIGS. 4A and 4B, there are provided block diagrams for describing a system and method of storing event data and performing a text query according to the present invention. In FIG. 4A, the database control unit 211 preferably includes a data associator 401 for associating input data, an A/V data unit determiner 403 for providing A/V data unit ID to the data associator 401, and a relational database engine 405 for transferring event data to the event data storage unit 219.

The data associator 401 receives from the event processor 221 event texts, each of which is obtained by defining an event or object. Each event can be associated with a logical channel. In other words, each event can be defined by the event processor 221 in association with one or more of the virtual drivers (341-345 in FIG. 3). The data associator 401 may also receive text data from an external text generator 407 which generates text data when an event occurs therein. For example, an automated-teller machine (ATM) located within a monitored area can generate text data relating to a transaction whenever a transaction occurs in the ATM. The text data may be transferred to the data associator 401 through an extra channel.

The data associator 401 may receive text data from one or more external text generators. The data associator 401 also receives A/V data unit ID from the A/V data unit determiner 403 which receives A/V data from the channel mapper 203. Each A/V data unit ID identifies an A/V data unit having a predetermined amount, for example, 3 MB A/V clip.

Upon receiving event text, external text, and A/V data unit ID, the data associator 401 associates the input data with each other to form event data as shown in FIG. 4B. For the event data associated with an event, an event text defining the event, A/V data unit ID identifying an A/V data unit corresponding to the event, and external text relating to the event (optional) are arranged to form a data packet. Such event data from the data associator 401 is provided to a relational database engine 405 where the event data is organized in accordance with predetermined formats to be stored in the event data storage unit 219.

The event data storage unit 219 preferably has a relational database for the event data which is previously organized by the relational database engine 405. The relational database may be organized, for example, as a set of formally-described tables from which event data can be accessed or reassembled in many different ways without having to reorganize the database tables. The standard user and application program interface to a relational database is the structured query language (SQL). SQL statements may be used for interactive queries for information from a relational database. In addition to being relatively easy to create and access, a relational database has the important advantage of being easy to extend. After the original database creation, a new data category can be added without requiring that all existing applications be modified. In other words, a relational database is a set of tables containing data fitted into predefined categories. Each table contains one or more data categories in columns. Each row contains a unique instance of data for the categories defined by the columns.

When a user searches A/V data stored in the A/V data storage unit (209 in FIG. 2), an object or event can be found by performing a sequential search with respect to the stored A/V data. The sequential search is performed by retrieving the stored A/V data sequentially and finding a target object and/or event during the retrieval. Such sequential search is well known in the art, thus a detailed description thereof is omitted.

As an alternative to the sequential search, the system of the present invention facilitates a user to perform quick searches, such as by a text query using the event data stored in the event data storage unit 219. In a text query, a user inputs a query text to a processor (now shown) where the query text is compared with event texts of the event data stored in the event data storage unit 219 until finding one or more event texts corresponding to the query text.

Since each event text is associated with A/V data unit ID, corresponding A/V data can be identified by the A/V data unit ID and retrieved from the A/V data storage unit 209. Then, the retrieved A/V data is decoded and transferred to the playback view unit (229 in FIG. 2). As a result, a target object or event for the text query is displayed on one or more windows of a screen in the playback view unit 229.

While a time period for performing the sequential search as in the prior art depends on the amount of A/V data stored in the A/V data storage unit 209, a time period for performing the text query according to the illustrative embodiment of the present invention is independent of the amount of the stored A/V data. Thus, a user can search an object or event from a large amount of stored A/V data at a high speed by using the text query.

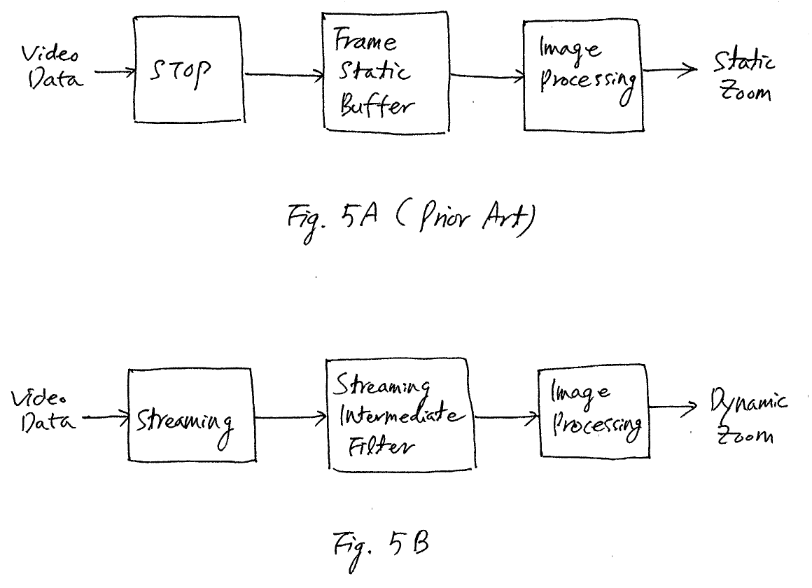

Referring to FIGS. 5A and 5B, there are provided comparative block diagrams for describing a static zoom and a dynamic zoom according to the present invention. The static zoom has sizes decided in hardware such as a capture board or a graphic adapter. In contrast, the dynamic zoom has sizes decided in software and user operation. Therefore, the dynamic zoom size can be varied to any size.

Having described preferred embodiments of a system and method of processing A/V data applicable to a monitoring system according to the present invention, modifications and variations can be readily made by those skilled in the art in light of the above teachings. All the detailed examples and terminology recited herein are principally intended to aid understanding the principles of the invention and the concepts contributed by the inventor to furthering the art. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. The functions of the various elements shown in the FIGS. 2 and 3 may be provided through the use of dedicated hardware as well as hardware capable of executing software in association with appropriate software.

It is therefore to be understood that, within the scope of the appended claims, the present invention can be practiced in a manner other than as specifically described herein.

What is claimed is:

1. A system for processing video data provided from a plurality of video sources, comprising:
a plurality of video data capture devices for receiving the video data, each of the video data capture devices receiving video data from a predetermined number of video sources;
a plurality of video drivers for driving output data of the video data capture devices for a first set of application programs, each of the video drivers receiving output data from corresponding one of the video data capture devices and being associated with corresponding one of the first set of application programs;
a plurality of virtual video drivers for driving input data for a second set of application programs, each of the virtual video drivers being associated with corresponding one of the second set of application programs; and
a video channel mapping unit for mapping data from the plurality of video drivers into the plurality of virtual video drivers.

2. The system of claim 1, wherein the plurality of video sources are interconnected to a local area network.

3. The system of claim 2, further including a plurality of remote video sources which are located remotely from the system via a communication network.

4. The system of claim 3, wherein the communication network includes a global computer network.

5. The system of claim 3, wherein the remote video sources include remotely located digital video recorders (DVRs) providing live and recorded video data.

6. The system of claim 3, wherein the video channel mapping unit maps data from the plurality of video drivers and the plurality of remote video sources into the plurality of virtual drivers.

7. The system of claim 1, further including:
a plurality of audio sources for providing audio data;
a plurality of audio data capture devices for receiving the audio data, each of the audio data capture devices receiving audio data from a predetermined number of audio sources;
a plurality of audio drivers for driving output data of the audio data capture devices for the first set of application programs, each of the audio drivers receiving output data from corresponding one of the audio data capture devices and being associated with corresponding one of the first set of application programs;
a plurality of virtual audio drivers for driving input data for the second set of application programs, each of the virtual audio drivers being associated with corresponding one of the second set of application programs; and
an audio channel mapping unit for mapping data from the plurality of audio drivers into the plurality of virtual audio drivers.

8. The system of claim 7, wherein the plurality of video sources and the plurality of audio sources are combined to form a plurality of audio and video (A/V) sources for generating A/V data.

9. The system of claim 8, wherein the plurality of video data capture devices and the plurality of audio data capture devices are combined to form a plurality of A/V data capture devices for receiving the A/V data from the plurality of A/V sources.

10. The system of claim 9, wherein the plurality of video data capture devices process the A/V data at a speed of about 150 frames per second.

11. The system of claim 9, wherein the plurality of virtual video drivers and the plurality of virtual audio drivers are combined to form a plurality of virtual A/V drivers each of which drives input A/V data to be processed in accordance with corresponding one of the second set of application programs.

12. The system of claim 11, wherein the video channel mapping unit and the audio channel mapping unit are combined to form an A/V channel mapping unit for mapping data from the plurality of A/V drivers into the plurality of virtual A/V drivers.

13. The system of claim 12, wherein the number of the A/V data capture devices varies from one (1) to five (5).

14. The system of claim 13, wherein the number of the A/V sources associated with each of the A/V data capture devices varies from one (1) to sixteen (16).

15. The system of claim 14, wherein the number of the virtual drivers varies from one (1) to forty-eight (48).

16. The system of claim 12, further including a plurality of remote audio sources for providing audio data to the A/V channel mapping unit, each of the remote audio sources being combined with corresponding one of the remote video sources to form a remote A/V source.

17. The system of claim 12, wherein the plurality of A/V data capture devices each have an analog-to-digital (AID) convert function for converting analog A/V signals from the plurality of A/V sources into digital A/V data provided to the plurality of A/V drivers.

18. A method for processing audio and video (A/V) data provided from various A/V sources, comprising the steps of:
providing physical local channels for transmitting A/V data provided from local A/V sources, each of the physical local channels transmitting A/V data from corresponding one of the local A/V sources;
providing logical channels virtually created in association with various application programs, each of the logical channels driving input data to be processed in accordance with corresponding one of the various application programs; and
mapping the physical local channels into the logical channels such that A/V data transmitted via each of the physical local channels is provided as input data to corresponding one or more of the logical channels.

19. The method of claim 18, wherein the step of providing physical local channels includes:
capturing analog A/V signals of at least one object or event using the various A/V sources; and
converting the analog A/V signals into digital A/V data.

20. The method of claim 18, wherein the number of the logical channels varies depending on the number of the various application programs.

21. The method of claim 18, wherein the various application programs associated with the logical channels include at least one application program for displaying A/V data in an A/V display unit.

22. The method of claim 18, further including providing physical remote channels for transmitting A/V data provided from remote A/V sources via a communication network including a global computer network.

23. The method of claim 22, wherein the mapping step includes mapping the physical remote channels into the logical channels such that A/V data transmitted via each of the physical remote channels is provided as input data to corresponding one or more of the logical channels.
